(19) United States
(12) Patent Application Publication
(10) Pub. No.: US 2025/0128969 A1
(43) Pub. Date: Apr. 24, 2025

(54) FLUID TREATMENT APPARATUS WITH INTEGRAL CLEANING SYSTEM

(71) Applicant: Ralph SUDDATH, Hickory Creek, TX (US)

(72) Inventor: Ralph SUDDATH, Hickory Creek, TX (US)

(21) Appl. No.: 19/002,122

(22) Filed: Dec. 26, 2024

Related U.S. Application Data
(63) Continuation-in-part of application No. 18/382,220, filed on Oct. 20, 2023.

(51) Int. Cl. C02F 1/38; B04C 3/00; B04C 9/00; C02F 1/00; C02F 1/48; C02F 101/20

(52) U.S. Cl. CPC C02F 1/38; B04C 3/00; B04C 9/00; C02F 1/008; C02F 1/48; B04C 2003/006; C02F 2101/203; C02F 2201/004; C02F 2209/003; C02F 2209/005; C02F 2209/02; C02F 2209/05; C02F 2209/06; C02F 2209/40; C02F 2301/026; C02F 2303/04; C02F 2303/14; C02F 2303/20; C02F 2303/22

(57) ABSTRACT

A fluid treatment apparatus is provided that introduces rapidly spinning vortices to a portion of a circulating fluid system, such as water. The apparatus includes a vortex creation module comprised of a plurality of micro-spheres and means for sending a variety of electrical currents and frequencies through the plurality of micros-spheres in vortex creation module. The vortices prepare the fluid to have memorized electromagnetic frequency signatures of harmful materials erased, and a new, desirable signature introduced. The desirable frequency can be introduced though a number of means, such as an electrical frequency generator. The desirable frequencies make the fluid an inhospitable environment for biological contaminants, such as bacteria, algae, and fungi, reducing their numbers in the fluid. The apparatus further includes an integral cleaning system that includes an electrical system capable of reversing the polarity of an electrical current across the plurality of micro-spheres within the vortex creation module as a means for restoring the effectiveness of the system.

### CROSS-REFERENCE TO RELATED APPLICATION

This application is a continuation-in-part of U.S. patent application Ser. No. 18/382,220 filed on Oct. 10, 2023, the technical disclosure of which is hereby incorporated herein by reference.

### BACKGROUND OF THE INVENTION

### Background

Applicant'sinvention relates to a device for treating fluids and a method for same. More specifically, it relates to a fluid, and particularly water, treatment system to reduce contaminants such as bacteria, algae, and fungus in the fluid without the use of chemicals.

Earth's water is continually cycled via a natural circulation system. Water moves from pools, streams, lakes, and rivers to the sea, it evaporates and enters the atmosphere, falls from the air back to earth, is absorbed into the ground, collects in underground aquifers, and re-emerges from underground through springs.

Water that has not been substantially affected by humans may be referred to as “natural water.” Humans use the circulating “natural” water and then return it to the circulation cycle. Unfortunately, often humans' use pollutes the water, resulting in “unnatural water.” A characteristic of “unnatural water” is that it attracts and is susceptible to the growth of unhealthy contaminants such as bacteria, algae, and fungus. It has an altered state of pH, and a higher surface tension than “natural water.”

Water emits an electromagnetic frequency (EMF) that can be measured. Natural water has its own EMF signature. However, water is an energy seeking substance that picks up frequencies from minerals, chemicals, and other substances it contacts. When this happens the water's EMF signature is altered to mimic that of the impurities. Thus, water can be said to have “memory.” Even though water can be chemically or mechanically “purified” with the intention of ridding the water of as many polluting substances as possible, it still carries memorized electrical frequencies, in specific frequency bands (wavelengths). After any purification, chemical treatment, filtration, or even after distillation, the pollutants' harmful frequency information remains in the water. The memorized EMF signature can be tracked precisely to the detrimental substances which were in the water before treatment.

As noted in U.S. Pat. No. 5,711,950, “when sodium chloride is dissolved in water, water molecules surround the sodium and chloride ions to produce ion hydrates. The resulting geometry or the water molecules differs from that of the prior clusters of hydrogen-bonded water molecules. The water molecules become more highly ordered and regular in structure. The addition of sodium chloride to microclustered water effects the same result. Thus, the sodium chloride may be said to function as a “template” for the change.” This template or “pattern” is what secures the change in the water, locking in the extraordinary structure produced by this invention.

A molecule's shape can be as important to function as its composition. Electronic bonding patterns, determined by cluster shape, alter the behavior and properties of all phases of matter. When electrons are shared by the whole cluster in a de-localized pattern, negative charge is evenly distributed and the cluster may take on certain aspects of solid metal, such as conductivity. When the electrons are all tightly bound to atoms, the clusters resemble discrete molecules.

The covalent bonding of two hydrogen atoms to one oxygen atom forms the water molecule (H₂O). To complete its outer shell, oxygen needs two electrons, and it obtains these by sharing an electron with each or two hydrogen atoms. These bond to the oxygen atom to form a triangular structure. This shape is important because it forms the basis for many of the solutions and compounds that support life.

A water molecule's covalent bonds are polar in that the bonded atoms share electrons, but the electrons are attracted more strongly to the oxygen nucleus than to the hydrogen nuclei. This creates a small positive charge near the two hydrogen nuclei. Clusters of water molecules form because the positive charges of the hydrogen atoms are attracted to the negative charge of the oxygen atoms from other water molecules. It is well known that such hydrogen bonds play important roles in many biological compounds, and is essential for maintaining the shape or large molecules such as proteins and nucleic acids.

The pattern or clustering of water is evidenced by the ability to photograph a crystal formed by the water. A crystal is a solid substance with orderly-configured atoms and molecules. In addition to being in snow and crystallized quartz, crystals are also seen in natural minerals such as diamonds and table salt. When a water molecule crystallizes, pure or “natural” water becomes pure crystal, but contaminated, chemically treated “dead” or “unnatural” water may not crystallize in the natural tetrahedron. Water treated by the present invention crystallizes in the same manner as “natural” water.

The vortex is a universal background of nature. Vortices deliver energy and are tools that nature uses to assemble and disassemble its creations. Vortices form matter, shape it and hold it together. They guide processes by centripetally charging and feeding growth and then centrifugally discharging it and throwing it back to death or non-motion. A vortex is an orderly, consistent, regenerating technology.

Vortices exist in water such as in creeks, rivers, or in the air. Within every stream, water constantly circles in small vortices called eddies. The same movement is seen in the waves of the ocean constantly rolling in spiral movements. This motion causes water to gather electrical force. Water stores this potential energy. The centripetal, inward-directed movement of water causes it to become rejuvenated.

Implosion causes matter to move inwardly. This inward (centripetal) motion does not follow a straight path to the center, but a spiraling whirling path—a vortex. The outside of the vortex moves slowly and the center moves much more quickly. As water is imploded, suspended particles, which are denser than water are sucked into the center of the flow, frictional resistance is reduced and the speed of the flow increased. Changes of the chemical properties in the water have been reported, including changes of the oxygen content, surface tension is reduced, and the precipitation and bonding of metal ions occurs.

Thus, there is a need for a method and device for erasing the memory of polluted water, and changing the water's EMF signature from that of a pollutant to that of natural water.

Prior art devices have demonstrated some ability to modify the quality of water to some degree. Most have employed a ring or horseshoe shaped magnet to fit over the outside of the plumbing to affect the polarization of the water molecule. Others have employed DC current wire coils to offset the same outcome. A few have inserted DC electrodes into the water cavity to modify the quality of the water. Others have used a high voltage electric discharge to produce ozone in a closed chamber with resulting gas being injected into the water flow thus sterilizing the water.

That some magnetic treatments of water can have lasting effects on water is known. X-ray crystallography and electron microscopy have been used to examine scale formed by hard water. The scale formed by untreated water and by magnetically treated water is different. There is a difference in the scale from the treated and untreated water, which extends for at least several days.

For example, CEPI-CO, of Belgium has sold hundreds of thousands of its anti-magnetic water treatment to reduce scaling in industrial cooling circuits. These magnetic water treatment units are in continuously recirculating systems and are solely for the purpose of scale suppression. Nevertheless, their useful results prove that magnetic treatment of water can have lasting beneficial effects and can cause changes in the water's crystallization behavior. These results have only been obtained via dynamic magnetic treatment, i.e., the fluid moving rapidly through an orthogonal magnetic field to produce semi-permanent changes in the water.

Further, magnetic fields are also known to reduce the surface tension and viscosity of water. Studies have shown that magnetic treatment of water can alter the effectiveness of certain types of bacterially mediated oxidation of pollutants.

The instant invention likewise non-chemically treats water in a way that imparts a beneficial memory, or semi-permanent effect, of the treatment to the water.

There are previous apparatus for magnetically treating fluid. The magnetic field is normally applied axially by winding an electromagnetic coil about a tube or vessel through which the fluid is passed. Thus, efficiency is poor as the applied voltage is increased near the magnets, and decreased in the center of the tube. The field strength is non-uniform, and as a result is ineffective.

U.S. Pat. No. 3,873,448; This invention is described as “a magnetic separator having particular utility in separating ferromagnetic materials with sizes on the order of microns from viscous fluids”. The separator utilizes a ferromagnetic filler in the form of a bed of ferromagnetic particles through which the fluid is passed. The magnetic field established in the filter extends transversely to the direction of fluid flow. Electromagnetic coils in a position relative to electromagnets cause the field. The invention further required flushing when the filter medium is filled with particles. In addition the DC potential on the coil, must be then changed to an AC potential. This caused demagnetization of the particles forming the filler. The filter medium is described as “steel shot or other particles constituting filter,” and as a layer of seven inches thickness of one-sixteenth Inch stool shot” in this design. There is no reference to the significance of the round balls of the steel shot, and the patent appears to only use it as a filter that can be magnetized. While this invention does include round steel shot as a filter, its purpose is as a separator of ferromagnetic materials.

U.S. Pat. No. 4,836,932: This invention uses a “water treatment cell” producing locally strong “super magnetic fields (60,000 to 250,000 Gauss).” This is accomplished when minute highly intense magnetic fields are produced, with stabilization of micro-magnet geometry. These fine particles are dispersed in nonmagnetic media. This “super magnet” is then placed in a vessel for treating the water. Minerals such as ionized calcium in the water precipitate out as calcium powder at the bottom of the vessel. This technology is primarily used to separate waste materials from the water. In addition, a turbulent flow is required, but may need to be adjusted. The invention's intended use is in a recirculating system for descaling. No round balls or magnets are used, and the water is passed into a vessel containing these super magnets.

U.S. Pat. No. 3,869,390: This mechanism is an electromagnetic filter for removing iron oxide from the feed water of boilers in steam power plants. It includes a filter bed of metal balls in a vessel with an excitation coil located about the vessel. The coil has passages for cooling and a jacket allows for openings for the cooling medium. The magnetic field is produced outside the balls. This device is a filter that requires DC and AC current, and is limited to a specific use.

U.S. Pat. No. 4,501,661: This invention claims to provide a method and apparatus for purifying and activating water, to obtain natural-like water being fungi-free clean and rich in taste and minerals. The device consists of three chambers: 1. The first a deceleration zone using an agent in porous granular form with an ability to decompose combined chlorine and absorbs free chlorine, such as calcic ceramic (obtained from shells of shellfish and treating them at ultrahigh temperature. 2. The second chamber is an activation zone where water is disordered with its equilibrium state and ionized. The water will be neutral or weak-alkaline in this zone. This is accomplished by using charged particles of Elvan (magnetic multielementary mineral) and magnet bars installed longitudinally among said particles. 3. The third chamber, the settlement zone is to disturb the ionic balance of water and orient it to be softened. This chamber contains a magnet ball of acrylic resin, which contains a magnetic pellet in its free space. The number of balls could be as few as three. This device is complex, contains many mediums of treatment, and does not use the magnetic balls for flow or direction, but only as a source of a magnetic field. The magnetic field is not claimed to dechlorinate, as a medium is claimed to accomplish that in the first chamber. The use of magnetic balls is not comparable to the present invention.

U.S. Pat. No. 4,904,381: This device is an apparatus for magnetization treatment of fluid by having a rotor with a magnetic field generator rotatably in a passage or reservoir of fluid, and a rotating means coupled to the rotor. Treatment is effected by a magnetic field generator, which is rotated integrally to generate a rotating magnetic field in its surroundings. Again, a filter member is applied to the water in a chamber containing small balls formed of a permanent magnet and gold or silver-plated. Each produces a static magnetic field against the water and narrow gaps serve to remove impurities contained in the water. The inventor states that the filter member need not be limited to round ball magnets, but might be of ceramics containing Ca, Mg and other elements effective for drinking water and agricultural products. The magnetic field generator comprises a plurality of permanent magnets. An air suction pipe is provided to increase water flow rate, producing bubbles to increase oxygen content of water. The filter member, round magnet balls, is used remove impurities not to treat the water. Water treatment and changes occur due to the magnetic field generator rotating in the first chamber.

More recently, the Applicant has disclosed in U.S. Pat. Nos. 7,238,289 and 7,473,372 systems and methods that introduce rapidly spinning vortices in a fluid, such as water, that includes a vortex creation apparatus and a frequency generation device. The vortices prepare the fluid to have memorized electromagnetic frequency signatures of harmful materials erased, and a new, desirable signature introduced. The desirable frequency can be introduced through a number of means, such as electricity, sound waves, and magnetic fields, using such devices as power leads, speakers, transducers, and magnets. The desirable frequencies make the fluid an inhospitable environment for biological contaminants, such as bacteria, algae, and fungi, reducing their numbers in the fluid. The fluid may be passed through a plurality of magnetic micro-spheres to interact with the water molecules to polarize mineral salts preventing the formation of deposits on the inside of related plumbing.

While the systems and methods disclosed in U.S. Pat. Nos. 7,238,289 and 7,473,372 are effective in erasing the electromagnetic frequency signatures of harmful materials in a fluid and introducing desirable frequency signatures, over time it has been observed that the micro-spheres in the vortex creation apparatus gradually lose their effectiveness due to a coating of mineral deposits contained in the fluid that forms on the micro-spheres of the vortex creation apparatus. It has been found that this loss in effectiveness can be detected by observing a decline in the conductivity of the system and the treated fluid. The coating of mineral deposits on the micro-spheres gradually diminishes the effectiveness of the vortex creation apparatus, which in turn results in a gradual decrease in its ability to effectively treat the fluid.

While the degradation of the vortex creation apparatus can be remedied by replacing the used vortex creation apparatus, such an option is expensive and wasteful. Moreover, it is inefficient to do so, especially if the vortex creation apparatus is a component part contained within a larger treatment system. In addition, testing and experience has revealed that the previously disclosed vortex creation apparatus can be simplified and used more efficiently and effectively. Thus, there is a continued need for an improved method and device for erasing the memory of a polluted or contaminated fluid, and changing the fluid's EMF signature from that of the pollutant to that of natural water, that further includes an integral method and device, which periodically cleanses the micro-spheres to maintain their effectiveness.

### SUMMARY OF THE INVENTION

The present invention includes an apparatus and system that introduces rapidly spinning vortices in the fluid. The vortices prepare the fluid to have memorized EMF signatures of harmful materials erased, and a new, desirable signature introduced. The present invention further incorporates a means for adding a desirable frequency to the fluid. In addition, the apparatus of the present invention further includes an integral cleaning system and method that periodically cleanses the micro-spheres to maintain their effectiveness.

While the device previously disclosed in related, co-pending U.S. patent application Ser. No. 18/382,220 filed on Oct. 10, 2023, (the technical disclosure of which is hereby incorporated herein by reference) includes a system that detects when the micro-spheres of the vortex creation module lose their effectiveness due to a coating of mineral and/or biological deposits contained in the fluid and automatically dispenses a biologic cleaning fluid to cleanse the micro-spheres, the present embodiment includes an electrical system capable of reversing the polarity of the current across the vortex creation module as a means for restoring the effectiveness of the system. The polarity reversal system of the present invention may be activated/deactivated periodically or in response detecting when the micro-spheres of the vortex creation module lose their effectiveness due to a coating of mineral and/or biological deposits contained in the fluid.

The present invention provides a novel apparatus that will treat water, or other fluids, in a manner that returns them to their natural states. Further objectives of the present invention are:
a. To provide for treatment of polluted water and fluids.
b. To reduce or eliminate the need for chemical sanitizers such as chlorine, bromine, stabilizers, algaecides, and clarifiers in swimming pools, spas, cooling towers, municipal and other water systems.
c. To provide treatment of other fluids to provide clusters to make them more efficient and effective.
d. To reduce surface tension of water.
e. To retard growth of algae, bacteria, and fungus in water.
f. To increase electrical conductivity.
g. To establish hydrogen bonding. Water is either structured or unstructured, dependant upon whether or not hydrogen bonding connects clusters of water molecules together or not. Water that is structured with hydrogen bonding will have a more balanced pH.
h. To simplify the construction and operation of components of the apparatus and system.
i. To automatically clean the micro-spheres of the vortex creation module of the apparatus and system of the present invention when needed.

Under normal conditions, natural clustering or water molecules is short lived and the cluster size is unpredictable. The present invention changes the cluster pattern of the water or other fluids, causing change to be long lasting. Water which has been treated to have a more ordered and stable structuring of water molecules has been produced by other inventions using magnetic treatment of the water, but none has imparted a new pattern or cluster to the water, thereby, they have been unable to “hold” the change in the water. They do not complete the process needed to remove the negative programming and impart new programming, thereby semi-permanently changing the water.

The present invention removes the negative “frequencies or programming,” structure the water to receive a new program, and impart that program to the water. This process will cause the improvements in the water to be longer lasting, without constant recirculation of the water through the device.

It is anticipated that the present invention will be useful for industries such as: municipal water treatment, pool and spas, hotels and restaurants, air conditioning, agriculture, food and beverages. Among other effects, the present invention has been measured to reduce the surface tension of tap water from 72 to 62 dynes per centimeter. The semi-permanent nature of the described effects makes the treatment useful for pools, municipal water supplies, and the like.

The improved system includes a simplified vortex creation module that does not require strands of different metals. In addition, the apparatus and system of the present invention further includes an integral electronic cleaning system and method that reverses the polarity of an electrical current across the vortex creation module as a means for restoring the effectiveness of the system. For example, in one embodiment of the present invention the integral cleaning system and method includes a electronic system that is activated/deactivated periodically (either manually or, preferably, automatically) in accordance with a programmed timing device that includes a polarity reversal system, which reverses the polarity of an electrical current across the vortex creation module. The programmed timing device may reverse the polarity for a period of time every minute, day or month as necessary. In another embodiment, the integral cleaning system and method of the present invention includes a polarity reversal system that is activated/deactivated in response to a sensor that detects when the micro-spheres of the vortex creation module lose their effectiveness due to a coating of mineral and/or biological deposits contained in the fluid.

In addition, testing and experience have revealed a more optimal way of employing the apparatus and system of the present invention to more effectively and efficiently retard growth of algae, bacteria, and fungus in water.

### BRIEF DESCRIPTION OF THE DRAWINGS

A more complete understanding of the method and apparatus of the present invention may be had by reference to the following detailed description when taken in conjunction with the accompanying drawings, wherein:

FIG. 1A is a front perspective view of an embodiment of the present invention;

FIG. 1B is a front elevation view of thereof with the housing cover removed;

FIG. 2 is a partially exploded front perspective, view of the embodiment of the present invention shown in FIG. 1 with its housing cover in an opened position,

FIG. 3A is a cross-sectional perspective view of the upper tubular coupler section and vortex creation module shown in FIG. 2;

FIG. 3B is a cross-sectional elevation view thereof

FIG. 3C is a partial cross-sectional elevation view of the upper tubular coupler section and vortex creation module shown in FIG. 2 showing the inserted electronic terminals and electrodes; and

FIG. 4 is a close-up exploded view of an electric terminal shown in FIGS. 2 and 3C.

Where used in the various figures of the drawing, the same numerals designate the same or similar parts. Furthermore, when the terms “top,” “bottom,” “first,” “second,” “upper,” “lower,” “height,” “width,” “length,” “end,” “side,” “horizontal,” “vertical,” and similar terms are used herein, it should be understood that these terms have reference only to the structure shown in the drawing and are utilized only to facilitate describing the invention.

All figures are drawn for ease of explanation of the basic teachings of the present invention only; the extensions of the figures with respect to number, position, relationship, and dimensions of the parts to form the preferred embodiment will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

### DETAILED DESCRIPTION OF THE PREFERRED EMBODIMENTS

The fluid treatment apparatus of the present invention includes a simplified and improved fluid treatment apparatus. The present invention includes an improved design for a vortex creation module that does not require strands of different metals. In addition, the apparatus and system of the present invention further includes an integral electronic cleaning system that causes an electric current to run across the vortex creation module for a period of time and then reverses the polarity of the current running across the vortex creation module for a second period of time as a means for restoring the effectiveness of the system. The integral electronic cleaning system of the present invention may be activated/deactivated either periodically or in response to a system that detects when the micro-spheres of the vortex creation module lose their effectiveness due to a coating of mineral and/or biological deposits contained in the fluid. For example, in one embodiment of the present invention the integral electronic cleaning system is activated/deactivated periodically (either manually or, preferably, automatically) in accordance with a programmed timing device. The programmed timing device may activate/deactivate the integral electronic cleaning system every minute, hour, day or month as necessary. In another embodiment, the integral electronic cleaning system is activated/deactivated in response to an accessory system that detects when the micro-spheres of the vortex creation module lose their effectiveness due to a coating of mineral deposits contained in the fluid.

Testing and experience have revealed a more optimal way of employing the apparatus and system of the present invention to more effectively and efficiently retard growth of algae, bacteria, and fungus in water. It has been found that only a portion of the total fluid that passes through the system needs to pass through the vortex creation module to effectively treat the fluid to retard or eliminate a sufficient amount of biological contaminants such as bacteria, algae, and fungi. Indeed, it has been found that the system can effectively treat a 12,000-gallon pool by operating once or twice a month for 4-12 hours.

While a preferred embodiment of the present invention is described and depicted in the Figures, the principals and lessons of the disclosed apparatus, system and methods are applicable to a wide variety of applications. For example, pool water or municipal water may be treated in accordance with the above specification, and scaled up or down as needed depending upon the volume of the water to be treated, the expected time period between treatments, and the extent to which the water is polluted. The fluid treatment apparatus will more benignly kill biological active components of the treated fluid than other methods of killing such biological active components. Heavy chlorination, a sufficiently intense magnetic field, and sufficient pressure will all kill bacteria. However, the present invention kills bacteria more economically and with semi-permanent effects, in other words, water treated by the present invention resists reinfection by biological contaminants such as bacteria, algae, and fungi.

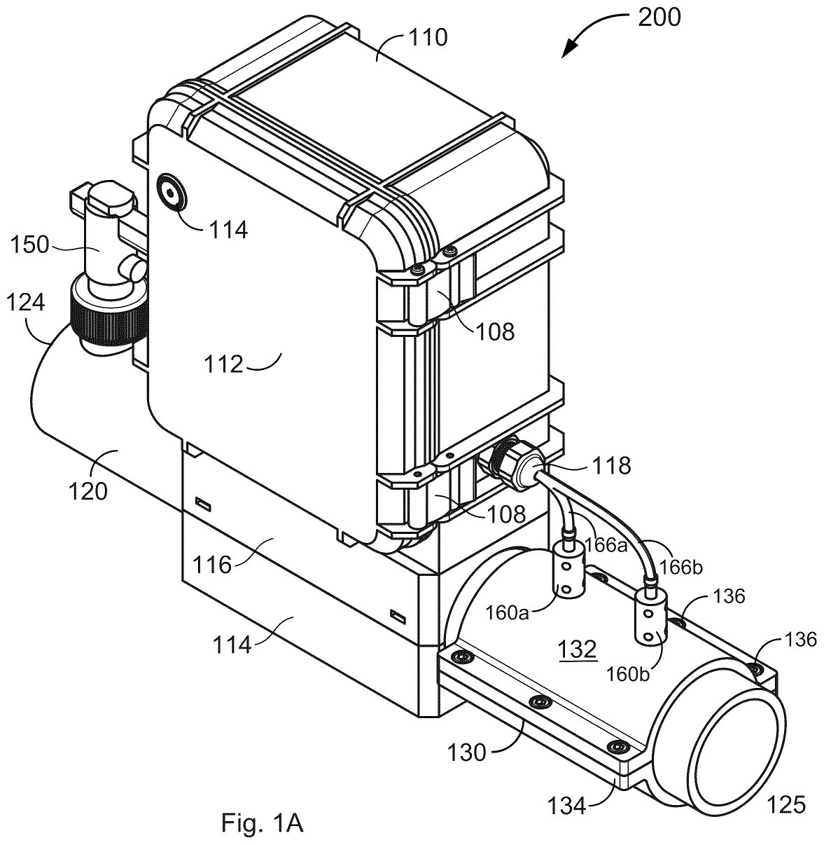

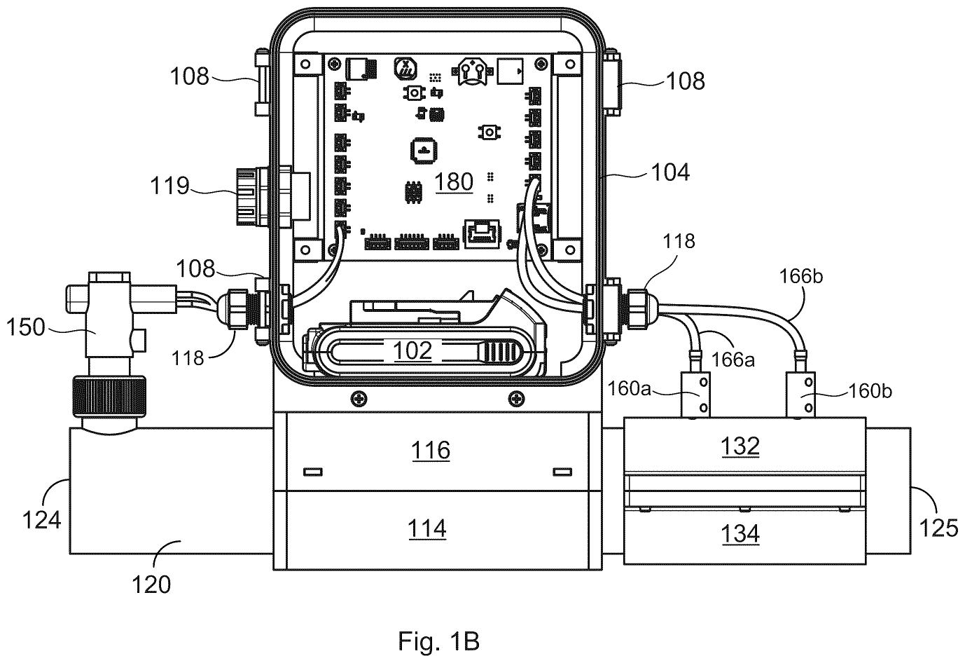

With reference to FIGS. 1A-1B, a front perspective and front elevation of an embodiment of the present invention are depicted. The fluid treatment apparatus 200 comprises a main housing 110 having an attached cover or door 112. The main housing 110 may further include one or more mounting brackets (not shown) incorporated therein or holes formed in the back wall of the main housing 110 for mounting the housing 110. The main housing 110 may further include one or more air vents (not shown) for supplying and exhausting ambient air to and from the interior of the main housing 110.

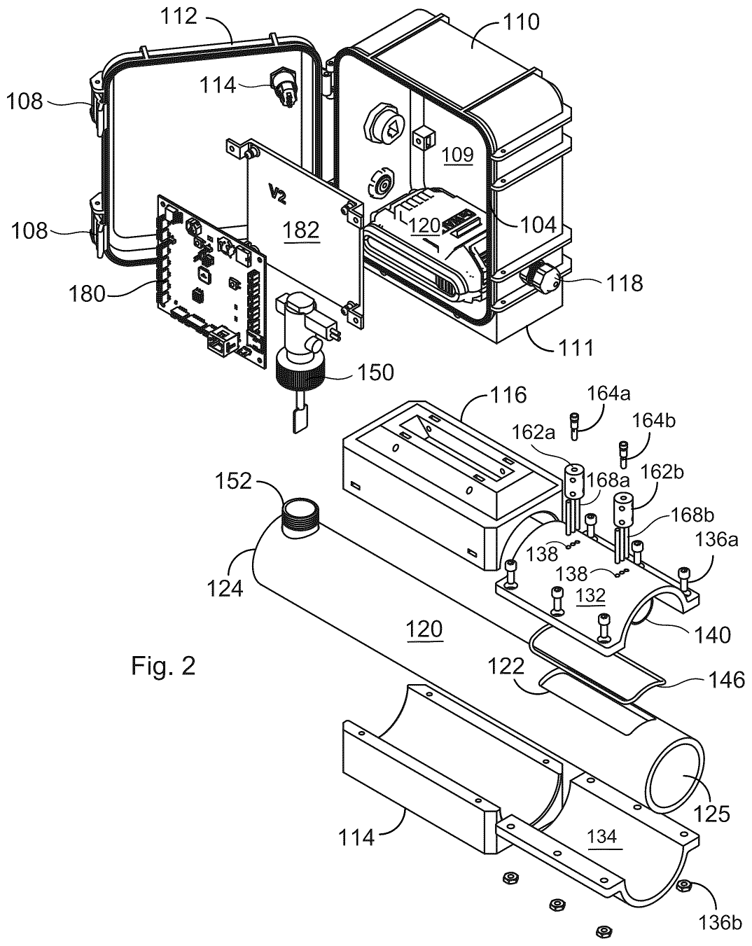

The main housing 110 and attached cover 112 are constructed of a durable non-corrosive waterproof material such as metal or thermoplastic. One or more latching hinge mechanisms 108 may be used to attach the cover 112 to the main housing 110. With reference again to FIGS. 1B and 2, the fluid treatment apparatus 200 may also include a gasket 104 configured between the main housing 110 and attached cover 112 for sealing the main housing 110 and attached cover 112 together. In addition, connecting devices, such as screw fasteners (not shown) or tension latching hinge mechanisms 108, may be used to attach and seal the cover 112 to the main housing 110.

The cover or door 112 of the main housing 110 may also include an on-off master control switch 113 for connecting/disconnecting electrical power to an electronic control unit (ECU) 180. In one embodiment, the ECU 180 comprises a printed circuit board (PCB) mounted to a vertical partition or wall 182 that is attached to the back wall of the main housing 110. The ECU 180 includes a variety of electronic and computerized components that monitor and control the functional operation of the fluid treatment apparatus 200. The ECU 180 may comprise one or more microcontrollers, signal boards and other integrated circuitry for programming, storing and executing computerized programs that control and supply electrical power and frequencies to the various components of the fluid treatment apparatus 200. For example, in one embodiment the ECU 180 comprises a full H-bridge driver, or preferably two half H-bridge drivers, wherein each output is driven independently by a microcontroller.

The cover 112 of the fluid treatment apparatus 200 may also include a computerized display (not shown) for operating and programming the fluid treatment system. Preferably, the ECU 180 of the fluid treatment apparatus 200 may be programmed via a wired or wireless communication device to program the fluid treatment system 200. The display (not shown) may include various buttons or be a touchscreen, and displays operating information to the user of the apparatus 200. The display (not shown) may further include an interface connector plugged into a slot on the

ECU 180. While the interface connector may be a hard-wired electrical connection, it is understood that in alternative embodiments the display can be electronically connected to the ECU 180 with a wireless computerized connection. Preferably, the display of a wireless computerized device is used to program and control the ECU 180 of the fluid treatment system 200. The ECU 180 powers and controls all of the component systems of the fluid treatment apparatus 200.

With reference now to FIGS. 1B and 2, the interior of the main housing 110 is designed to be dry and contains the electronic and control devices of the apparatus 200. The main housing 110 may comprise a power supply electrically connected to the ECU 180 by means of a power supply cable (not shown). The power supply may comprise an alternating current or, preferably, a direct current. For example, the power supply may comprise a hard-wired electrical connection connected to an inverter or a battery 102 as depicted in the Figures. The power supply could also comprise a rechargeable battery with an attached hard-wired recharging system. The power supply may also comprise a solar collector or panel for recharging the battery system. Alternatively, the power supply may comprise a hydro-electric generator device (not shown) configured within the interior of the main flow tube 120 that generates electricity whenever fluid is flowing through the main flow tube 120.

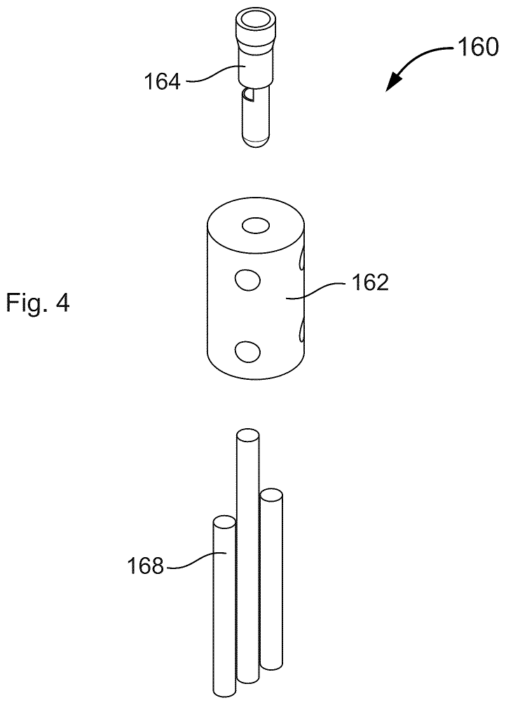

The ECU 180 includes inputs from the power supply and one or more sensors. The output side of the ECU 180 is electrically connected to one or more electronic terminals 160 configured within a coupling device 130 attached to the main flow tube 120. As shown in FIG. 4, each electronic terminal 160 comprises a connector shaft 164 connected to a terminal body 162 and multiple electrode rods 168, which are inserted into a vortex creation module 140 incorporated into the coupling device 130. In a preferred embodiment the connector shaft 164 is steel and the multiple electrode rods 168 are tungsten. As shown in FIG. 1B, each of the electronic terminals 160 are connected electronically to and powered by the ECU 180 by means of electrical connectors 116 wired through a waterproof gland fitting 118. The output side of the ECU 180 provides separate output signals via electrical connectors (e.g., 166) to each electronic terminal 160a, 160b. Each of the output signals (i.e., Signal A to terminal 160a and Signal B to terminal 160b) is driven independently by a microcontroller (not shown) within the ECU 180. For example, Signal A and/or Signal B may be set to ground. Signal A and/or Signal B may be set to a specified voltage. Signal A and/or Signal B may be set to floating. Signal A and/or Signal B may be set to a given frequency in the same polarity. Signal A and/or Signal B may be set to a given frequency but with an opposite or opposing polarity.

The fluid treatment apparatus 200 further includes a main flow tube 120 for conveying fluid for treatment. In contrast to the embodiment of the device previously disclosed in related, co-pending U.S. patent application Ser. No. 18/382,220 filed on Oct. 10, 2023, (the technical disclosure of which is hereby incorporated herein by reference) the main housing 110 of the fluid treatment apparatus 200 is completely isolated from the fluid flow through the main flow tube 120. While the main housing 110 may be attached in close proximity to the exterior of the main flow tube 120 using a pipe housing fitting, the fluid flow through the main flow tube 120 is isolated from the interior of main housing 110. For example, as shown in the Figures the pipe housing fitting may comprise a two-piece pipe housing fitting 114, 116 that securely clamps or grips the exterior surface of the main flow tube 120. The upper pipe housing section 116 is attached to the exterior bottom or underside 111 of the main housing 110. While the depicted embodiment shows the fluid treatment apparatus 200 having the main housing 110 physically attached to the main flow tube 120 it is understood that the main housing 110 unit may be configured at a location remote from the main flow tube 120 with only wired electrical or wireless connections connecting the main housing 110 and the main flow tube 120.

The main flow tube 120 contains a fluid passageway for configuring components of the fluid treatment apparatus 200 in the fluid flow of a a circulating pipeline (not shown). The main flow tube 120 comprises a fluid inlet 124 connected to a fluid supply line (not shown), which supplies a continuous stream of fluid for treatment, and a fluid outlet 125, which channels the treated fluid via an outlet line (not shown) back to a circulating supply reservoir (not shown). While the main flow tube 120 in the depicted embodiment appears to be a separate tube adapted to be spliced into a circulating pipeline, it is understood that the main flow tube 120 may simply be a length of the circulating pipeline in which apertures are cut or formed so as to receive component parts of the fluid treatment apparatus 200.

With reference now to FIG. 2, the main flow tube 120 includes a rectangular port or aperture 122 formed therein upsteam of the fluid outlet 125 to receive a vortex creation module 140 attached to the coupling device 130. For example, as shown in the embodiment depicted in the Figures, the coupling device 130 comprises a two-piece tubular coupling unit having an upper coupling section 132 attached to a lower coupling section 134 by means of fasteners 136a, 136b. The underside 133 of the upper coupling section 132 includes a vortex creation module 140 extending therefrom, which when properly configured is positioned within the interior of the main flow tube 120 so as to access a portion of the fluid flowing through the main flow tube 120. A gasket 146 configured around the rectangular port or aperture 122 may be positioned between the underside 133 of the upper coupling section 132 and the main flow tube 120 to seal the upper coupling section 132 to the main flow tube 120.

The upper coupling section 132 also includes apertures or holes 138 for receiving multiple electrode rods 168 attached to an electronic terminal 160. As will later be described in greater detail, the apertures or holes 138 extend through the upper coupling section 132 and into the body of the vortex creation module 140. The multiple electrode rods 168 are connected electronically to, and are powered and controlled by the ECU 180 by means of electrical connectors 116 wired through a waterproof gland fitting 118. While the coupling device 130 is shown in the depicted embodiment in close proximity to the main housing 110 of the fluid treatment apparatus 200 it is understood that the coupling device 130 may be configured anywhere on the circulating pipeline and linked via electrical connections to the ECU 180 in the main housing 110.

With reference again to FIG. 2, the main flow tube 120 may include a port 152 to receive a sensor 150 that is connected electronically to the ECU 180. For example, the sensor 150 may comprise a flow sensor that detects the flow of fluid through the main flow tube 120. The flow sensor detects the flow of fluid through the main flow tube 120 and notifies the fluid treatment system by sending an electronic signal to a signal board in the ECU 180. The flow sensor 150 may communicate with the ECU 180 via a hard-wired electrical connection via a waterproof gland fitting 118 or via a wireless communication device connection with the ECU 180. In addition, or alternatively, the sensor 150 may further comprise one or more sensors for detecting or measuring characteristics of the fluid (e.g., temperature, conductivity, pH and flow rate) flowing through the main flow tube 120. While the sensor port 152 shown in the depicted embodiment is in close proximity to the main housing 110 of the fluid treatment apparatus 200 it is understood that the sensor 150 may be configured anywhere on the circulating pipeline with only electrical (wired or wireless) connections linking with the ECU 180 in the main housing 110. Moreover, a series of ports similar to port 152 may be configured at remote locations along the circulating pipeline to detect or measure individual characteristics of the fluid (e.g., temperature, conductivity, pH and flow rate) flowing through circulating pipeline and communicating with the ECU 180.

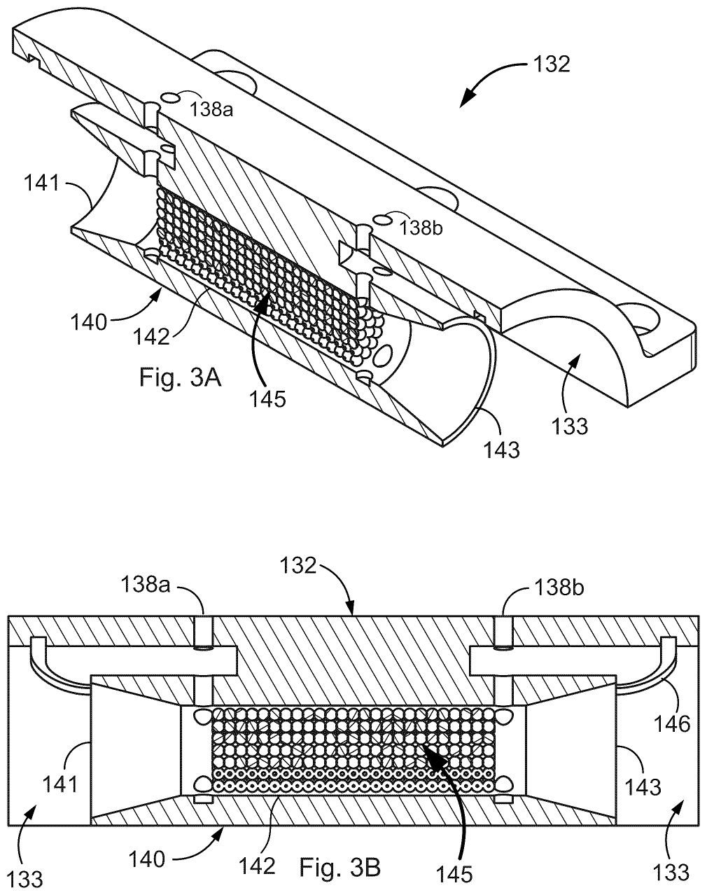

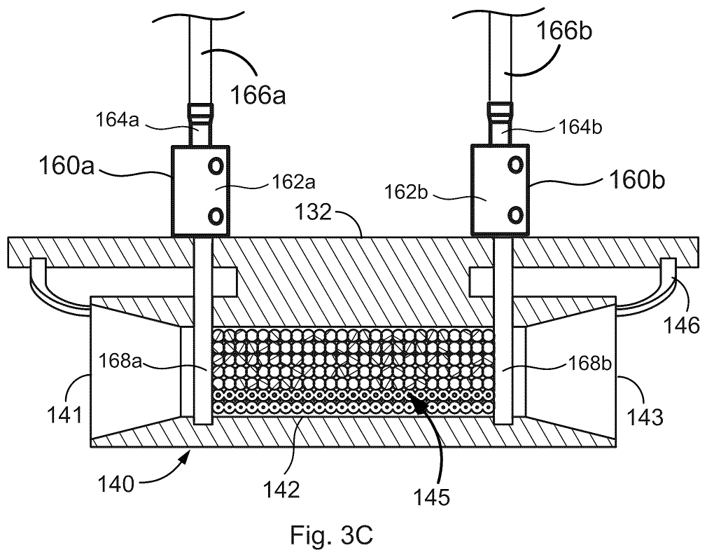

With reference now to FIGS. 3A-3C, cross-sectional views of the vortex creation module 140 are shown. The vortex creation module 140 of the present invention is similar, yet simplified, in form and function to the tubular vortex chamber members previously disclosed in Applicant's U.S. Pat. Nos. 7,238,289 and 7,473,372, the disclosures of which are incorporated by reference. For example, the vortex creation module 140 of the present invention does not require the use of metallic strands as in previously disclosed embodiments. Moreover, the vortex creation module 140 of the present invention does not require a separate strainer device to hold the plurality of micro-spheres 145 in place as used in prior embodiments.

As shown in the Figures, the vortex creation module 140 has a tubular body that extends from the underside 133 of the upper coupling section 132 of the coupling device 130 so as to access a portion of the fluid flowing through the main flow tube 120. The tubular body of the vortex creation module 140, which is generally aligned with the flow of the fluid through the main flow tube 120, includes an inlet 141 fluidly connected to a cylindrical bore 142, which in turn is fluidly connected to an outlet 143. As shown in the depicted embodiment, the inlet 141 may have a converging or narrowing conical bore while the outlet 143 may have a diverging or expanding conical bore.

A plurality of micro-spheres 145 are contained within the cylindrical bore 142 of the tubular body of the vortex creation module 140. The plurality of micro-spheres 145 are held in place by means of the previously mentioned multiple electrode rods 168a, 168b that extend through the apertures or holes 138 formed in the upper coupling section 132 and into the body of the vortex creation module 140. The aperture or holes 138a, 138b are configured on opposing ends of the cylindrical bore 142 of the tubular body of the vortex creation module 140. The multiple electrode rods 168a, 168b may be sealed within their respective apertures or holes 138a, 138b by means of a compression fitting or sealant (e.g., epoxy) and are in contact with some of the plurality of micro-spheres 145 on opposing ends of the cylindrical bore 142 of the vortex creation module 140.

The multiple electrode rods 168 are dimensioned and spaced so as to constrain the plurality of micro-spheres 145 to within the cylindrical bore 142 but allow the flow of fluid through gaps between the adjacent individual rods. The plurality of micro-spheres 145 conduct electricity and frequencies between the two electrode rods 168a, 168b. Preferably, the micro-spheres are tungsten and not magnetic. Preferably, but not necessarily, there might also be intermittent interstitial gaps between either of the two electrode rods 168a, 168b and adjacent micro-spheres constrained within the cylindrical bore 142, so that electricity has to flow through the fluid while passing through the plurality of plurality of micro-spheres 145. The use of tungsten carbide alloy micro-spheres has been found to be superior in performance compared to other materials. The vortices are created by the plurality or series of contiguous rows of micro-spheres 145.

While the coupling device 130 is shown in the depicted embodiment in close proximity to the main housing 110 of the fluid treatment apparatus 200 it is understood that the coupling device 130 may be configured anywhere on the circulating pipeline and linked via electrical connections (e.g., 166) to the ECU 180 in the main housing 110.

The vortex creation module 140 of the present invention is designed to create vortices in the fluid (not shown). As the water (not shown) flows in between the spaces of the micro-spheres 145 it is subjected to intense turbulence and many vortices. The micro-spheres 145 are metal and preferably made of a tungsten carbide alloy.

As depicted in FIGS. 3A-3C, the micro-spheres 145 may be arranged into a plurality of ordered parallel rows, although it is not required. The micro-spheres 145 may be configured in stacked or offset rows. Ideally, each micro-sphere should be in contact with another micro-sphere to allow better fluid and current flow, although tiny intermittent interstitial gaps filled with water may sporadically exist between some adjacent micro-spheres. Such formations are dependant upon the dimensions of the cylindrical bore 142 of the vortex creation module 140 and the diameters of the individual micro-spheres 145. The number of micro-spheres 145 in each row and their positioning can be modified to fit the vortex creation module 140.

In order to ensure creation of the vortices and increase their energy, fluid (not shown) may be passed through the vortex creation module 140 using relatively high pressure, often at least 20 psi. The pressure allows longer fluid contact with the micro-spheres 145 and a uniformity of exposure. However, such pressure is not required in all cases. The vortices generated by the vortex creation module 140 act to erase the EMF memory from the water (not shown) and prepare it to accept the frequencies generated by the ECU 180.

The fluid treatment apparatus 200 of the present invention includes numerous modes of operation. As previously noted, the ECU 180 can send a wide variety of discrete signals, frequencies and voltages to the electrode rods 168a, 168b configured in the vortex creation module 140. Each of the output signals (i.e., Signal A to electronic terminal 160a and Signal B to electronic terminal 160b) is driven independently by a microcontroller (not shown) within the ECU 180. A wide variety of combinations are possible coming from driving each of the two signals to any of the following states while the other can also be driven into any of the following (same) states. For example, Signal A and/or Signal B may be set to ground. Signal A and/or Signal B may be set to a specified voltage. Signal A and/or Signal B may be set to floating. Signal A and/or Signal B may be set to a given frequency in the same polarity. Signal A and/or Signal B may be set to a given frequency but with an opposite or opposing polarity.

The ECU 180 of the present invention includes at least two basic modes of operation. One mode (Mode 1—single pin/rod mode) comprises utilizing only a single electronic terminal (e.g., 160b) connected to a frequency generator configured in the ECU 180. The other terminal (e.g., 160a) is switched to floating. The electrode rods 168 of the single electronic terminal (e.g., 160b) acts as a frequency antenna that is electrically connected to the vortex creation module 140. In this mode of operation, practically no current flows across the plurality of micro-spheres 145 in the vortex creation module 140 because it is effectively an open circuit. Only a neglible current flows due to the parasitic capacitance flows. The electrode rods 168 of the single electronic terminal (e.g., 160b) are energized by a frequency generator within the ECU 180 and used to impart a frequency upon the fluid. The frequency generator supplies power to the electrode rods 168 of the single electronic terminal (e.g., 160b). Using pulse width modulation, the ECU 180 can vary the frequency, duty cycle and pauses between pulse trains. For example, in one embodiment the electrode rods (e.g., 168b) of the single electronic terminal (e.g., 160b) imparts positive frequencies upon the fluid (not shown) prior to it leaving the vortex creation module 140 to create a permanent change to the EMF memory of the fluid. The multiple electrode rods (e.g., 168b) of the single electronic terminal (e.g., 160b) may comprise a single lead connected to the frequency generator with no ground lead provided. In this case, the electrical circuit between the multiple electrode rods (e.g., 168b) of the single electronic terminal (e.g., 160b) and the frequency generator is not complete. The power that is passed to the multiple electrode rods (e.g., 168b) of the single electronic terminal (e.g., 160b) is DC current with variable frequencies of up to 1000 Hertz. Thus, frequency is released into the water (not shown) near the exit of the vortex creation module 140. The multiple electrode rods (e.g., 168b) of the single electronic terminal (e.g., 160b) are in contact with some of the plurality of micro-spheres 145 forcing the DC current into the water via the plurality of micro-spheres 145 electrons generating ions. If the fluid (not shown) is water (not shown), the modified water (not shown) is known as clustered water (not shown). The multiple vortices created by the plurality of micro-spheres 145 cause a centripetal, inward-directed, movement of the water (not shown). This natural centripetal movement infuses the energy patterns into the water (not shown), causing a long-lasting change

Another mode of operation of the ECU 180 of the present invention (Mode 2—two pin/rod mode) comprises using both electronic terminals (e.g., 160a, 160b) whereby electrical current flows through one terminal and returns through the other terminal. Using pulse width modulation, the ECU 180 can vary the frequency, duty cycle and pauses between pulse trains. In addition, the ECU 180 can invert the polarity of the current flow by manipulating the output signals to the electronic terminals 160a, 160b causing the reverse of current flow across the plurality of micro-spheres 145 in the vortex creation module 140.

Through experimentation it has been found that reversing the polarity of the current flow across the vortex creation module is an effective means for restoring the effectiveness of the system. It has been found that when the plurality of micro-spheres 145 attract enough mineral and/or biological deposits the effectiveness of the system decreases. Nonetheless, reversing the polarity of the current flow across the vortex creation module acts to repel previously attracted mineral and/or biological deposits from the plurality of micro-spheres 145 thereby restoring the effectiveness of the system. The integral electronic cleaning system and method the present invention reverses the polarity of an electrical current across the vortex creation module as a means for restoring the effectiveness of the system. The integral electronic cleaning system of the present invention may be activated/deactivate periodically or in response to a system that detects when the micro-spheres of the vortex creation module lose their effectiveness due to a coating of mineral and/or biological deposits contained in the fluid. For example, in one embodiment the polarity reversal system of the integral electronic cleaning system in the ECU 180 is activated/deactivated periodically (either manually or, preferably, automatically) in accordance with a programmed timing device. For example, the programmed timing device may activate the microprocessor to reverse the polarity every minute, hour, day or month as necessary.

In another embodiment, the integral cleaning system and method of the present invention includes a polarity reversal system that is activated/deactivated in response to a system in the ECU 180 that detects when the micro-spheres of the vortex creation module lose their effectiveness due to a coating of mineral and/or biological deposits contained in the fluid. For example, the ECU 180 may continually monitor the fluid flowing through the main flow tube 120 of the fluid treatment apparatus 200 of the present invention. A conductivity sensor configured in the ECU 180 continually monitors the conductivity of the system and fluid. For example, in one embodiment the ECU 180 includes a sensor that constantly monitors the impedance of the power supplied to vortex creation module 140. The ECU 180 monitors the back voltage of the conductivity sensor to generate a current or base measurement. As the impedance increases (i.e., conductivity decreases) a micro-processor in the ECU 180 increases the power supplied (i.e., voltage) to the electronic terminals 160a, 160b via pulse width modulation of DC variable voltage.

When the plurality of micro-spheres 145 attract enough mineral and/or biological deposits the monitored conductivity of the fluid and system decreases. As the measured current drops, the ECU 180 increases the duty cycle until it approaches a maximum degradation level or threshold in comparison with the base measurement demonstrating that a sufficient percentage of the conductivity has fallen indicating the vortex creation module 140 is sufficiently fouled and in need of cleaning. The ECU 180 activates the Mode 2 or two pin/rod mode, whereby electrical current flows through a first terminal (e.g., 160a) through the plurality of micro-spheres 145 and returns through a second terminal (e.g.,, 160b) for a first period of time. Upon conclusion of the first period of time the polarity reversal system of the integral electronic cleaning system in the ECU 180 is activated/deactivated so that the electrical current flows through second terminal (e.g., 160b) through the plurality of micro-spheres 145 and returns through the first terminal (e.g.,, 160b) for a second period of time. The polarity reversal system of the integral electronic cleaning system in the ECU 180 may be activated/deactivated periodically (either manually or, preferably, automatically) in accordance with a programmed timing device. For example, the programmed timing device may activate the microprocessor to reverse the polarity every minute, hour, day or month as necessary. Reversing the polarity of the current flowing across the vortex creation module acts to repel previously attracted mineral and/or biological deposits from the plurality of micro-spheres 145 thereby restoring the effectiveness of the system. It should be understood that such cleaning is typically only necessary on a very infrequent basis (e.g., every 6 months to 1 year), depending upon the physical and chemical characteristics of the water.

Any trace mineral salts in the water (not shown) will be polarized upon passing through the terminal, on its way out of the system. This results in the suspension of all material in the water (not shown) due to polarization and the prevention of any deposits (called scaling) being allowed to form on the inside of the fluid system (not shown) as randomly polarized mineral salts can do.

pH is the balance between charges in the water (not shown). Wide variations in pH damage equipment and can reduce the effectiveness of chemicals. By organizing the water (not shown) using ions generated by the vortex creation module 140 causing suspended solids to precipitate out of the water, the pH becomes more stabilized.

The fluid flow travels in a straight path until encountering the plurality of micro-spheres 145 at which time it swirls around the plurality of micro-spheres 145 with strands of water (not shown) coming together to form micro-vortices (not shown). The plurality of micro-spheres 145 rapidly swirl the fluid (not shown) to be treated into many vortices among the electrified micro-spheres 145. The relatively high pressure on the fluid (not shown) moving it through the vortex creation module 140 subjects the fluid (not shown) to the effects of the described frequency generation device. The combination of the plurality of small, spherical micro-spheres 145, and high pressure passing the fluid (not shown) through the fluid treatment apparatus 200 at sufficient velocity to create vortices, act in combination to kill unwanted bio-material. An additional benefit can be the precipitation out of minerals such as iron, calcium, and magnesium, thus helping to prevent scaling.

Through experience it has been found that only a portion of the total fluid that flows through the system needs to pass through the vortex creation module to destroy a sufficient amount of biological contaminants such as bacteria, algae, and fungi. Moreover, it has been found that that the system should only operate periodically so that biological contaminants, such as bacteria, algae and fungi are prevented from acclimating to the EMF signature of the treated fluid. Experience has shown that a periodic treatments once or twice a month for 4-12 hours effectively treats a 12,000-gallon pool.

Although there are many disclosed and possible embodiments of the present invention, they work on the same principle and engage the same method. Each embodiment incorporates a fluid system (not shown), or fluid source (not shown), with a vortex creation apparatus and a frequency generation device. A portion of the fluid in the fluid passageway, for example water, is passed through a vortex creation module 140 creating a plurality of vortices. Generally, this is done using a secondary passageway formed within the main passageway that permits only a portion of the fluid flowing through the entire fluid passageway to flow through the vortex creation module 140. The secondary passageway comprises a chamber designed to house a vortex creation module to create vortices in the fluid. This is intended to erase the “memory” from biological contaminants from the fluid. It also readies the fluid to “memorize” a new, desirable frequency, which is applied though a number of means such as electricity, audio, and magnetic. The desirable frequencies make the fluid an inhospitable environment for the biological contaminants, such as bacteria, algae, and fungi, reducing their numbers in the fluid.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

I/We claim:

1. An apparatus for treating a fluid comprising:
a vortex creation module configured within a circulating fluid flow, said vortex creation module comprising a plurality of micro-spheres captured between two electronic terminals positioned on opposing ends of a cylindrical bore within said module, wherein said cylindrical bore is configured to access a portion of said circulating fluid flow;
an electronic control unit connected to said two electronic terminals by separate electrical connectors, wherein said electronic control unit provides a discrete electrical signal to each electronic terminal imparting an electrical frequency to said plurality of micro-spheres and fluid within said portion of said circulating fluid flow;
wherein said electronic control unit includes a means for cleaning said plurality of micro-spheres by sending a first electrical current across said plurality of micro-spheres from a first electronic terminal through said plurality of micro-spheres to a second electronic terminal for a first period of time and then inverting the polarity by sending a second electrical current from said second electronic terminal through said plurality of micro-spheres to said first electronic terminal for a second period of time.

2. The apparatus of claim 1, wherein said electronic control unit periodically activates and deactivates the cleaning means.

3. The apparatus of claim 2, wherein said electronic control unit includes a programmable timing device for activating and deactivating the cleaning means.

4. The apparatus of claim 2, wherein said electronic control unit includes a sensing device that activates and deactivates the cleaning means when said sensing device detects degradations in the effectiveness of the micro-spheres by monitoring decreases in the conductivity of the fluid through the vortex creation module.

5. The apparatus of claim 4, wherein the electronic control unit compares the current conductivity of the fluid to a historic base conductivity of the fluid.

6. The apparatus of claim 1, wherein each electronic terminal comprises a connector shaft, a terminal body and one or more electrode rods.

7. The apparatus of claim 6, wherein said connector shaft is steel.

8. The apparatus of claim 6, wherein said electrode rods comprise multiple prongs.

9. The apparatus of claim 6, wherein the electrode rods are tungsten alloy.

10. The apparatus of claim 6, wherein said electronic control unit sends a signal A to a first electronic terminal and a signal B to a second electronic terminal.

11. The apparatus of claim 10, wherein said signal A is set to:
a) ground;
b) a first specified voltage;
c) floating;
d) a first frequency in a first polarity; or
e) a second frequency in a second polarity.

12. The apparatus of claim 11, wherein said signal B is set to:
a) ground;
b) a second specified voltage;
c) floating;
d) a third frequency in said first polarity; or
e) a third frequency in said second polarity.

13. The apparatus of claim 12, wherein said electronic control unit includes a frequency generator supplying electrical frequencies to said electronic terminals at up to 1000 Hz.

14. The apparatus of claim 1, wherein said electronic control unit includes a full H-bridge driver or two half H-bridge drivers to drive signals independently to each electronic terminal.

15. The apparatus of claim 1, wherein said circulating fluid flow is contained within a flow tube.

16. The apparatus of claim 15, wherein said vortex creation module is configured within said circulating fluid flow by forming an aperture in said flow tube and inserting said module through said aperture into said circulating fluid flow.

17. The apparatus of claim 16, further comprising a tubular coupler device for sealing said vortex creation module in said flow tube.

18. The apparatus of claim 17, wherein said tubular couple device comprises an upper tubular coupling section coupled to a lower tubular coupling section, wherein said upper tubular coupling section has an underside from which the vortex creation module extends.

19. The apparatus of claim 1, further comprising at least one sensor inserted into a port formed in said flow tube, wherein said electronic control unit is connected to said sensor, which detects a characteristic of the fluid.

20. The apparatus of claim 19, wherein said characteristic of the fluid is temperature, conductivity, pH or flow rate.

21. The apparatus of claim 19, wherein said electronic control unit is connected to said at least one sensor by means of wired or wireless electrical connections.

22. The apparatus of claim 1, wherein said electronic control unit is connected to a power source.

23. The apparatus of claim 22 wherein said electronic control unit and said power source are contained within a housing.

24. The apparatus of claim 22, wherein said housing is attached to a flow tube.

25. The apparatus of claim 22, wherein said power source is a direct current power source.
